(19) United States
(12) Patent Application Publication
(10) Pub. No.: US 2022/0062091 A1
(43) Pub. Date: Mar. 3, 2022

(54) VERSATILE HANDHELD MASSAGING SYSTEM

(71) Applicant: Raganpreet Kaur Rai, Tukwila, WA (US)

(72) Inventor: Raganpreet Kaur Rai, Tukwila, WA (US)

(21) Appl. No.: 17/002,588

(22) Filed: Aug. 25, 2020

(51) Int. Cl. A61H 7/00; A61H 23/02; H02J 50/10; G06F 1/16

(52) U.S. Cl. CPC A61H 7/007; A61H 23/0263; H02J 50/10; G06F 1/1632; A61H 2230/605; A61H 2201/0153; A61H 2201/5043; A61H 2023/0272; A61H 2007/009

(57) ABSTRACT

A handheld massaging system includes a handle unit, multiple head units and a charging platform. The system delivers a wireless massaging experience with multiple massaging motions and intensity levels provided by different head units. The massaging motions provided by the handheld massaging system include kneading and spinning motions. The charging platform provides a way to charge the handle unit and store the head units in an organized, aesthetically pleasing manner.

### BACKGROUND

A handheld massager is a device that typically includes a massaging head for applying pressure to an area of the body for the purpose of relieve muscle stiffness. Handheld massagers are usually small enough to be held by a user's hand for self-administered massages. Several high-end handheld massagers currently on the market provide a jackhammer motion. Users often find the jackhammer motion provided by these handheld massagers to be painful. Cheaper handheld massagers typically provide a vibrational motion. These cheaper massagers often do not provide effective massaging motion for relieving muscle stiffness.

### SUMMARY

This invention is directed to a handheld massaging system that includes a handle unit, multiple head units and a charging platform. The system delivers a wireless massaging experience with multiple massaging motions and intensity levels provided by different head units. The massaging motions provided by the handheld massaging system include kneading and spinning motions. The charging platform provides a way to charge the handle unit and store the head units in an organized, aesthetically pleasing manner.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows a handheld massaging system 100.

FIG. 2 shows example parts of handle unit 110.

FIG. 3 shows example internal components of handle unit 110.

FIG. 4 shows example head unit 121 that is implemented as a spherical head.

FIG. 5 shows example head unit 122 that is implemented as a roller head.

FIG. 6 shows example internal components of head unit 122.

FIG. 7 shows example head unit 123 that implemented as an elbow head.

FIG. 8 shows example charging platform 105.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

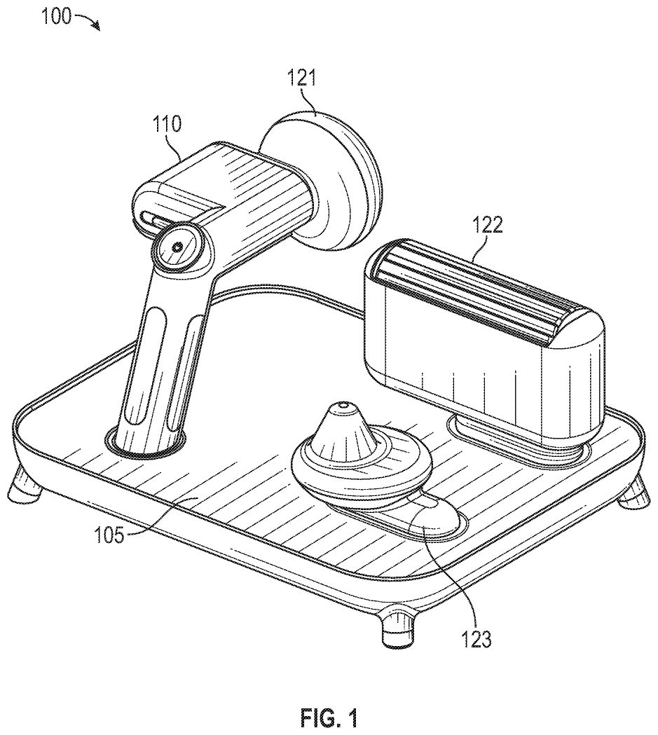

This invention is directed to a handheld massaging system 100 that includes a handle unit 110, multiple head units 121-123, and a charging platform 105, as shown in FIG. 1. Handle unit 110 is configured to operate wirelessly and can have its battery charged by charging platform 105. Handle unit 110 can be charged by charging platform 105 using a contact charging interface, such as by electrodes on handle unit 110 making contact with the electrodes on charging platform 105 and receiving electricity from charging platform 105. Alternatively, handle unit 110 can be charged through wireless charging. For example, handle unit 110 may include an induction coil that can receive electricity through charging by a corresponding induction coil in charging platform 105.

Handle unit 110 can be detachably coupled to one of the head units 121-123 through an output interface. The output interface provides mechanical output to the head units 121-123 to produce massaging motions. Handle unit 110 includes selection mechanisms for users to control the massaging motion by varying the mechanical output to head units 121-123. Handle unit 110 can also include indicator lights and display to provide information to users on varies states of the device and other information. Handle unit 110 may also receive signals from head units 121-123. These signals may include information such as states of head units 121-123, and signals and data from sensors of head units 121-123.

In one embodiment, handle unit 110 may present information on the display and indicator lights based on the received signals from head units 121-123. For example, handle unit 110 may receive signals from head units 121-123 that indicates muscle tension as sensed by the sensors of head units 121-123 and present information about muscle tension in the display. Users may then take this information into account in using and adjusting handheld massaging system 100.

In another embodiment, handle unit 110 may be configured to dynamically adjust the massaging motions based on sensor input, such as based on sensed muscle tension. For example, handle unit 110 may receive signals from head units 121-123 that indicates muscle tension as sensed by the sensors of head units 121-123 and automatically adjust the mechanical output to head units 121-123 based on sensed muscle tension as indicated by the received signals. In this manner, handheld massaging system 100 would be able to provide an amount of massaging motion consistent with sensed muscle tension and to dynamically adjust the massaging motion as muscle tension changes, such as when moving from one part of the body with low muscle tension to high muscle tension or when muscle tension eases in a given massaging session.

Head units 121-123 is configured to detachably coupled to handle unit 110 and to receive mechanical input through an input interface. Head units 121-123 can produce massaging motions from the mechanical input. These massaging motions may include a spinning motion and a kneading motion on the contact surface of head units 121-123. Head units 121-123 may also include a sensor for sensing muscle tension. Handheld massaging system 100 can be configured to provide the spinning motion and the kneading motion one at a time or both simultaneously.

Charging platform 105 is configured to provide electricity to handle unit 110 and to provide docking interfaces for head units 121-123. Charging platform 105 may also be configured to receive signals from handle unit 110 and head units 121-123 and to communicate with online services, such as through the Internet via a network like wifi, GSM, and the like.

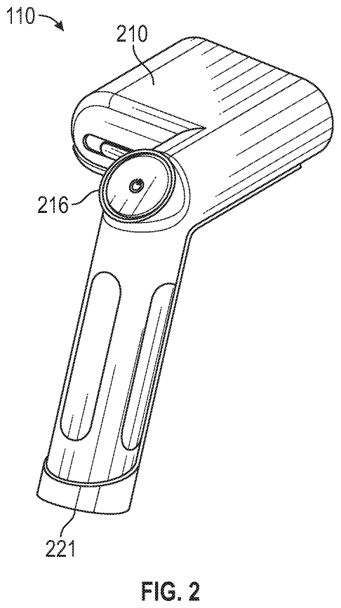

FIG. 2 shows example parts of handle unit 110. Handle docking interface 221 of handle unit 110 is used to connect to charging platform 105. Handle docking interface 221 may include an induction coil for wireless charging from a corresponding induction coil in charging platform 105. Handle output interface 223 is configured to provide mechanical output, such as kneading output and spinning output. The mechanical output is provided to the head units 121-123 to produce massaging motions, such as spinning motion and kneading motion.

Selector 216 is used to receive control user inputs for the operation on handle unit 110. It may be implemented as a power button such that handle unit 110 can be turned on or off in response to button activation. The power button may be pressed multiple times to select intensity levels. Selector 216 can also be implemented as a dial selector for varying the mechanical output of handle unit 110 such that intensity of the massaging motion produced by head units 121-123 can be controlled by turning the dial.

Handle unit 110 may also include a separate selector for selecting the type of massaging output to be provided, such as a spinning output for creating a spinning motion at head units 121-123 or a kneading output for creating a kneading motion, or both simultaneously. The selection of type of massaging output can also be implemented such that the selection is created by selector 216, such as by holding the power button for a period of time, repeatedly pressing the power button and the like.

Handle unit 110 may also include a display 210, which may be a LCD, LED, OLED, indicator lights, and the like. Display 210 may present information and data related to varies states of handle unit 110, such as battery charge level, massage motion selection, intensity, frequency, timing, and the like. Display 210 may also present information and data based on signals received from head units 121-123, such as sensed muscle tension levels. Display 210 may also be implemented as a touch screen device such that it can receive control inputs, such as those control inputs that can be received by selector 216.

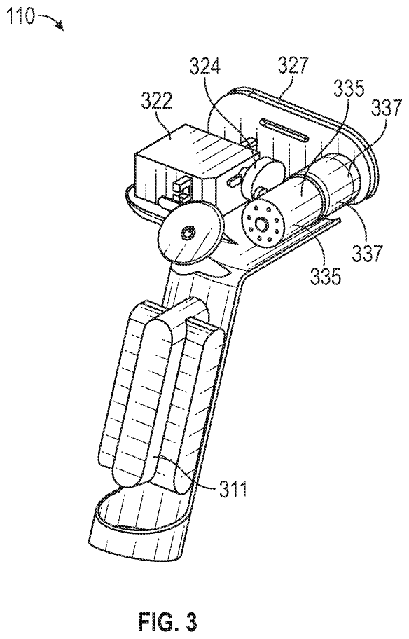

FIG. 3 shows example internal components of handle unit 110. Controller unit 322 is configured to control the operation of handle unit 110. It can receive power from battery 311 that is being charged through handle docking interface 221. Controller unit may receive user input through selector 216, display 210, and other controlling interface on handle unit 110. Servo motors 335-336 are controlled by controller unit 322 and provide mechanical outputs at the handle output interface 327. Servo motors 335-336 may be configured in various ways depending on design choices. For example, one of the servo motors may be configured to provide a kneading output and the other servo motor may be configured to provide a spinning output. Other configurations can also be implemented, such as using only one servo motor with alternative output selections, using three or more motors, varying the direction of motor spinning for kneading and spinning output, and the like.

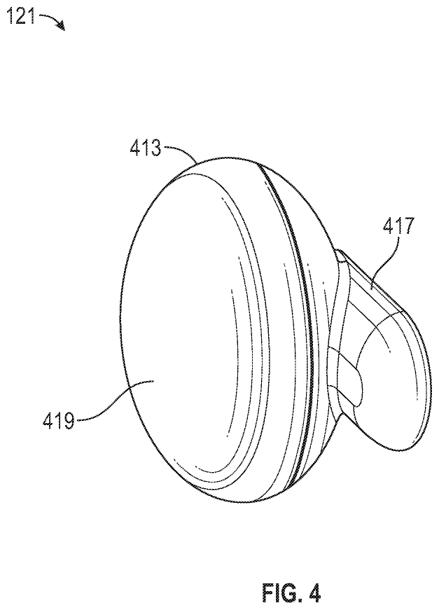

FIG. 4 shows example head unit 121 that is implemented as a spherical head. Head unit 121 includes a contact surface 419 for imparting massaging motion, such as to parts of a body. Head unit 121 can accept mechanical input from handle unit 110 through head interface 417. Head interface 417 can accept output from handle unit 110, such as spinning output and kneading output. In response to receiving a spinning output from handle unit 110, head unit 121 produces a spinning motion that causes the contact surface of the spherical head to rotate around one axis. In response to receiving a kneading output, head unit 121 produces a kneading motion that causes the contact surface of the spherical head to rotate about a point around a plurality of axes. Handheld massaging system 100 can be configured to provide the spinning motion and the kneading motion one at a time or both simultaneously. The kneading motion and the shape of the contact surface of the spherical head may simulate a particular massaging motion, such as by the palm of a massage therapist's hand.

Head unit 121 may include a sensor for sensing muscle tension. For example, a sensor may be embedded on contact surface 419 to sense tension associated with a body part, such as through electrical current, electrical resistance, skin resistivity, stain, pressure, and the like. The sensor may provide signals to handle unit 110 through head interface 417.

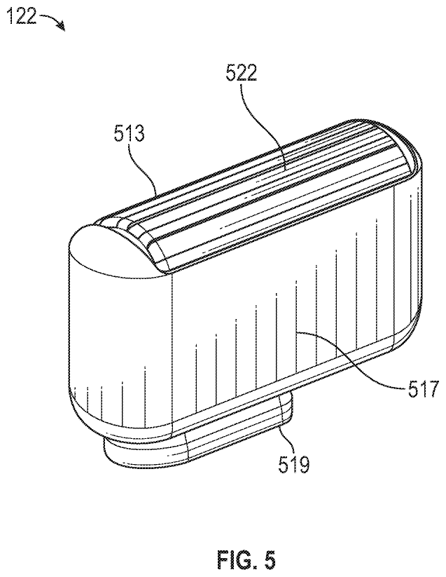

FIG. 5 shows example head unit 122 that is implemented as a roller head. Head unit 122 includes a contact surface on a rotatable cylinder 513. Head unit 122 can accept mechanical input from handle unit 110 through head interface 519. Head interface 519 can accept output from handle unit 110, such as spinning output and kneading output. In response to receiving a spinning output from handle unit 110, rotatable cylinder 513 spins around a longitudinal to provide a roller motion on the contact surface of rotatable cylinder 513. In one embodiment, in response to receiving a kneading output, head unit 122 can be configured to produce a kneading motion that causes the contact surface of the spherical head to rotate about a point around a plurality of axes. Head unit 122 implemented as a roller head may also be configured to provide no motion in response to a kneading output.

Head unit 122 may include a sensor for sensing muscle tension. For example, a sensor may be embedded on contact surface on rotatable cylinder 513 to sense tension associated with a body part, such as through electrical current, electrical resistance, skin resistivity, stain, pressure, and the like. The sensor may provide signals to handle unit 110 through head interface 519.

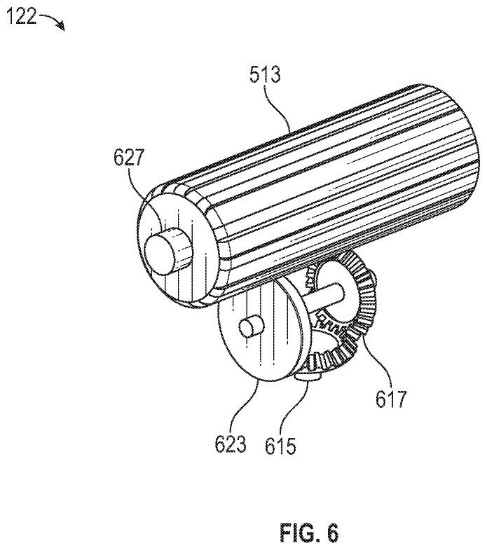

FIG. 6 shows example internal components of head unit 122. Rotatable cylinder 513 includes axle 627 which guides rotatable cylinder 513 to spin around the axis of axle 627. Spinning output from handle unit 110 is received through head interface 519 and imparts rotational motion to gear 615 and gear 617. Gear 617 spins a shaft to rotate friction wheel 623, which spins rotatable cylinder 513.

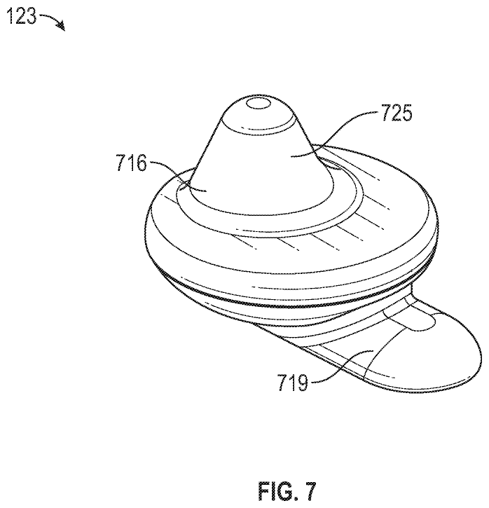

FIG. 7 shows example head unit 123 that implemented as an elbow head. Head unit 123 comprises a contact surface 716 that includes a flat portion and a pointed portion 725. Head unit 123 can accept mechanical input from handle unit 110 through head interface 719. Head interface 719 can accept output from handle unit 110, such as spinning output and kneading output. In response to receiving a spinning output from handle unit 110, head unit 719 produces a spinning motion that causes the contact surface of the elbow head to rotate around one axis. In response to receiving a kneading output, head unit 121 produces a kneading motion that causes the contact surface of the elbow head to rotate about a point around a plurality of axes. Handheld massaging system 100 can be configured to provide the spinning motion and the kneading motion one at a time or both simultaneously. The kneading motion and the shape of the contact surface of the elbow head may simulate a particular massaging motion, such as by the elbow of a massage therapist.

Head unit 123 may include a sensor for sensing muscle tension. For example, a sensor may be embedded on contact surface 716 to sense tension associated with a body part, such as through electrical current, electrical resistance, skin resistivity, stain, pressure, and the like. The sensor may provide signals to handle unit 110 through head interface 719.

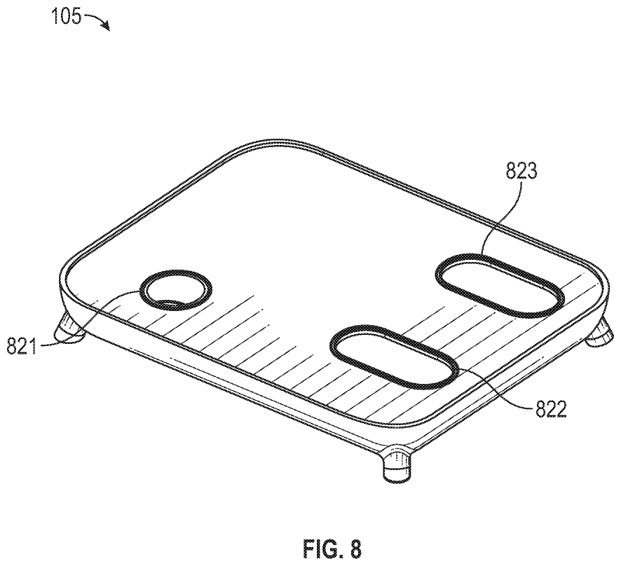

FIG. 8 shows example charging platform 105. Charging platform 105 includes electronics to receive line power from an electrical outlet and to convert the line power to electricity suitable for charging handle unit 110. Charging platform 105 includes a docking interface 821 for handle unit 110 that provides power through contact charging with contact electrodes, wireless charging through induction coils, or other suitable charging methods. Charging platform 105 also includes head interfaces 822-823 for receiving head units 121-123. In one embodiment, charging platform is configured to receive data from handle unit 110 and to communicate with Internet services through a network interface, such as that for wifi and other wireless network. In another embodiment, docking interface 821 and head interfaces 822-823 also include lights around the perimeter of the interfaces, such as a LED lighting. These lights may be on for decorative purposes. The lights around docking interface 821 may be configured to indicate a state of charge of handle unit 110, such as with different colors, flashing, or the like.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A massaging device comprising:
a handle unit including a handle output interface and a first handle docking interface, the handle unit also including servo motors that generate a spinning output and a kneading output at the handle interface, the first handle docking interface including a first induction coil for receiving electrical input for wireless charging;
a plurality of head units, each of the head units including a contact surface and a head interface that is configured to detachably couple to handle interface, each of the head units configured to receive the spinning output and the kneading output from the handle interface of the handle unit through the head interface, each of the head units also configured to convert the spinning output into a spinning motion on the contact surface and to convert the kneading output into a kneading motion on the contact surface; and
a charging platform including a second handle docking interface and a plurality of head docking interfaces, the second handle docking interface configured to receive the first handle docking interface and including a second induction coil for providing electrical output for wireless charging to the first induction coil of the first handle docking interface, the plurality of head docking interfaces configured to receive the plurality of head interfaces.

2. The massaging device in claim 1, wherein one of the plurality of head units is a spherical head and wherein the spinning motion causes the contact surface of the spherical head to rotate around one axis and the kneading motion causes the contact surface of the spherical head to rotate about a point around a plurality of axes.

3. The massaging device in claim 1, wherein one of the plurality of head units is an elbow head, wherein the contact surface of the elbow head includes a flat portion and a pointed portion, and wherein the spinning motion causes the contact surface of the elbow head to rotate around one axis and the kneading motion causes the contact surface of the elbow head to rotate about a point around a plurality of axes.

4. The massaging device in claim 1, wherein one of the plurality of head units is a roller head, wherein the contact surface of the roller head includes a rotatable cylinder, wherein the spinning motion causes the rotatable cylinder of the contact surface of the roller head to rotate around one axis.

5. The massaging device in claim 1, wherein the handle unit includes a selector for selectively activating the servo motors to generate a spinning output or a kneading output.

6. The massaging device in claim 1, wherein at least one of the head units includes a sensor on the contact surface to determine muscle tension and to output a signal receivable by the handle unit.

7. The massaging device in claim 6, wherein the handle unit includes a display and wherein the handle unit is further configured to determine a muscle tension level based on the received signal and to indicate the muscle tension level on the display.

8. The massaging device in claim 6, wherein the handle unit includes a data interface for communicating with another device and wherein the handle unit is further configured to determine a muscle tension level based on the received signal and to transmit data representing the muscle tension level to the other device through the data interface.

9. The massaging device in claim 6, wherein the handle unit is configured to determine a muscle tension level based on the received signal and to automatically adjust the spinning output and the kneading output based on the muscle tension level.

10. The massaging device in claim 6, wherein the sensor on the contact surface determines muscle tension by measuring skin resistivity.

11. A massaging device comprising:
a handle unit including means for generating mechanical outputs that comprises kneading output and a spinning output, means for controlling the mechanical outputs, and means for providing the mechanical outputs, and means for receiving electrical power;
plurality of head units including means for receiving the kneading output and the spinning output, means for converting the spinning output into a spinning motion on the contact surface, means for converting the kneading output into a kneading motion on the contact surface; and
a charging platform including means for providing power to the handle unit and means for providing docking interfaces to the plurality of head units.

12. The massaging device in claim 11, wherein the head units further comprising means for sensing muscle tension through the contact surface and means for providing a signal representing the muscle tension to the handle unit.

13. The massaging device in claim 12, wherein handle unit further comprising means for receiving the signal and means for displaying information representing the sensed muscle tension.

14. The massaging device in claim 12, wherein handle unit further comprising means for receiving the signal and means for automatically adjusting the mechanical output in response to the signal.

15. The massaging device in claim 12, wherein the charging platform further comprising means for lighting the means for providing power.

16. The massaging device in claim 15, wherein the means for lighting indicates a state of charge of the handle unit.

17. The massaging device in claim 12, wherein the charging platform further comprising means for lighting the docking interfaces.
